(19) United States
(12) Patent Application Publication
(10) Pub. No.: US 2006/0205859 A1
(43) Pub. Date: Sep. 14, 2006

(54) Polyurethane compositions with NCO and silyl reactivity

(76) Inventors: Thomas Bachon, Duesseldorf (DE); Hermann Kluth, Duesseldorf (DE); Felicitas Kolenda, Monheim (DE)

Correspondence Address: HENKEL CORPORATION, THE TRIAD, SUITE 200, 2200 RENAISSANCE BLVD., GULPH MILLS, PA, 19406, US

(21) Appl. No.: 11/430,708

(22) Filed: May 9, 2006

Related U.S. Application Data
(63) Continuation of application No. PCT/EP04/12951, filed on Nov. 16, 2004.

(30) Foreign Application Priority Data
Nov. 17, 2003 (DE) 103 53 663.9

(51) Int. Cl. C08G 18/42

(52) U.S. Cl. 524/500; 524/588; 524/589

(57) ABSTRACT

The invention relates to polyurethanes or polyureas, which carry both silyl groups and NCO groups and which can be produced while using asymmetric diisocyanates and substituted alkoxy aminosilanes, to preparations that contain reactive polyurethanes or polyureas that carry silyl groups, to methods for producing these reactive polyurethanes or polyureas that carry silyl groups, and to the use thereof.

This application is a continuation under 35 U.S.C. § 365(c) and 35 U.S.C. § 120 of international application PCT/EP2004/012951, filed on Nov. 16, 2004. This application also claims priority under 35 U.S.C. § 119 of DE 103 53 663.9, filed Nov. 17, 2003, which is incorporated herein by reference in its entirety.

### BACKGROUND OF THE INVENTION

This invention relates to compositions containing reactive polyurethanes or polyureas bearing silyl groups which can be produced using asymmetrical polyisocyanates and substituted alkoxyaminosilanes, to preparations containing these reactive polyurethanes or polyureas bearing silyl groups, to processes for the production of the reactive polyurethanes or polyureas bearing silyl groups and to their use.

Reactive polyurethanes or polyureas have reactive terminal groups which are capable of reacting with water or other compounds having an acidic hydrogen atom. This form of reactivity enables the reactive polyurethanes or polyureas to be brought to the required place in the required processable form, generally liquid or highly viscous, and cured by the addition of water or other compounds having an acidic hydrogen atom (known in this case as hardeners).

In these so-called two-component systems, the hardener is generally added immediately before application (normally with the aid of a mixing and dispensing system), only a limited processing time being available to the user after addition of the hardener.

However, polyurethanes or polyureas containing reactive terminal groups may also be cured solely by reaction with atmospheric moisture, i.e. without the addition of hardeners (one-component systems). One-component systems generally have the advantage over two-component systems that the user is spared the often onerous mixing of the frequently viscous components before application.

The polyurethanes or polyureas with reactive terminal groups normally used in one-component or two-component systems include, for example, polyurethanes or polyureas preferably terminated by isocyanate (NCO) groups.

In order to obtain NCO-terminated polyurethanes or polyureas, it is common practice to react polyhydric alcohols or polyamines with an excess of monomeric polyisocyanates, generally diisocyanates.

It is known that, irrespective of the reaction time, a certain quantity of the monomeric diisocyanate used is left over after the reaction for statistical reasons alone. Unfortunately, the presence of monomeric diisocyanate is generally problematical, particularly on health grounds, above all in the manual processing of adhesives, sealants and foams based on reactive polyurethanes or polyureas.

Even at room temperature, monomeric diisocyanates, such as IPDI or TDI, can have a significant vapor pressure. In view of the vapor pressure, measurable quantities of isocyanates constantly escape, even under normal processing conditions. In the absence of protective measures, the processor, for example, is exposed to the escaping isocyanates without any protection. This significant vapor pressure is serious above all in cases where the polyurethanes or polyureas are applied by spray application because, in this case, significant quantities of isocyanate vapors can occur in the vicinity of the application unit. Isocyanate vapors are toxic in view of their irritating and sensitizing effect and, in many countries, their emission has to be avoided on industrial hygiene grounds.

In addition, adhesives are often applied at elevated temperature. Thus, hotmelt adhesives are applied at temperatures of, for example, about 100° C. to about 200° C. while laminating adhesives are applied at temperatures of about 30° C. to about 150° C. At temperatures in these ranges, in conjunction with other specific application parameters, such as air humidity for example, even the widely used bicyclic diisocyanates, for example diphenylmethane diisocyanates, form gaseous and aerosol-like emissions. The low molecular weight diisocyanates mentioned above are readily released into the ambient air at such high temperatures.

Accordingly, many countries have introduced elaborate legal measures to protect the people responsible for applying the product, more particularly elaborate measures for keeping the surrounding air fit to inhale, so that the maximum permitted concentration of working materials as gas, vapor or particulate matter in the air at the workplace is limited and the health of the people involved in applying the products in question is protected (in Germany, for example; by the annually updated “MAK-Wert-Liste der Technischen Regel TRGS 900 des Bundesministeriums für Arbeit und Soziales”).

Since protective and cleaning measures generally involve considerable financial investment or costs, there is a need on the part of the user for products which have a low content of monomeric diisocyanates.

Not only does the application of reactive adhesives still containing monomeric polyisocyanate lead to problems. Even the marketing of materials and preparations containing, for example, more than 0.1% free MDI or TDI can be problematic in many countries. Materials such as these often come under existing laws on hazardous materials in many countries and have to be labeled accordingly. However, the labeling requirement often entails special packaging and transportation measures which can significantly increase the overall cost of the product.

Finally, containers holding reactive adhesives have to be labeled accordingly and separately disposed of in many countries. Accordingly, there is little enthusiasm for such products, particularly among end users.

The presence of monomeric volatile diisocyanate also leads frequently to problems during further processing. Thus, monomeric diisocyanates are capable of “migrating” from a coating or bond into the coated or bonded materials. Such migrating constituents are commonly known among experts as “migrates”. By contact with moisture, the isocyanate groups of the migrates are continuously reacted to amino groups. Unfortunately, the compounds formed are often carcinogenic.

Migrates of the type in question are particularly unwelcome in polyurethane integral foams which are used, for example, in the manufacture of steering wheels for motor vehicles, because contact of the amines formed from the migrated diisocyanates with the skin cannot be ruled out.

Migrates are also highly undesirable in the packaging industry and particularly in the packaging of foods. On the one hand, the passage of the migrates through the packaging material can lead to contamination of the packaged product; on the other hand, long waiting times are necessary before the packaging material is “migrate-free” and can be used, irrespective of the quantity of migratable free monomeric diisocyanate.

In Germany, for example, the content of the amines, particularly primary aromatic amines, formed by migrated diisocyanates must be below the detection limit—based on aniline hydrochloride—of 0.2 μg aniline hydrochloride/100 ml sample (Bundesinstitut für gesundheitlichen Verbraucherschutz und Veterinärmedizin, BGVV, nach amtlicher Sammiung von Untersuchungsverfahren nach § 35 LMBG—Untersuchung von Lebensmitteln/Bestimmung von primären aromatischen Aminen in wässrigen Prüflebensmifteln).

Another unwanted effect which can be caused by the migration of monomeric diisocyanates is the so-called antisealing effect in the production of bags or carrier bags from laminated plastic films. The laminated plastic films are often coated with a lubricant based on fatty acid amides. By reaction of migrated monomeric diisocyanate with the fatty acid amide and/or moisture, urea compounds with a melting point above the sealing temperature of the plastic films are formed on the surface of the film. This leads to the formation between the films to be sealed of a “foreign” layer which counteracts the formation of a homogeneous sealing seam.

Accordingly, the development of reactive polyurethanes or polyureas with a reduced content of monomeric diisocyanates is highly desirable for the reasons explained above.

EP 0 316 738 A1 describes a process for the production of urethane polyisocyanates with a content of urethane-free diisocyanate of at most 0.4% by weight by reaction of aromatic diisocyanates with polyhydric alcohols and subsequent removal of the unreacted excess diisocyanate, the removal of the excess diisocyanate being carried out by distillation in the presence of an aliphatic polyisocyanate.

EP 0 261 409 A1 describes alkoxysilane-terminated moisture-curing polyurethanes obtainable by a process in which almost all the free isocyanate groups are reacted with special alkoxysilanes. The disadvantage of such compositions lies in the fact that they contain hardly any isocyanate groups.

DE 38 15 237 A1 describes a process for reducing the monomer content of urethane- or isocyanurate-modified polyisocyanates based on 2,4-TDI or a mixture thereof with up to 35% by weight of 2,6-TDI or IPDI. The monomer reduction can be achieved by thin-layer distillation and subsequent reaction with water.

EP 0 393 903 A1 describes a process for the production of polyurethane prepolymers in which monomeric diisocyanate is reacted with a polyol in a first step. A catalyst is then added in a sufficient quantity, so that a considerable proportion of the remaining isocyanate groups is converted into allophanate groups. After the theoretical NCO content has been reached, the reaction is terminated by rapid cooling and addition of salicylic acid.

WO 01/40342 describes reactive polyurethane adhesive or sealant compositions based on reaction products of polyols and high molecular weight diisocyanates. In a first step, a diol component is reacted with a stoichiometric. excess of monomeric diisocyanate to form a high molecular weight diisocyanate and the high molecular weight diisocyanate is precipitated from the reaction mixture with the monomeric diisocyanate, for example by addition of a nonsolvent for the high molecular weight diisocyanate. In a second step, the high molecular weight diisocyanate is reacted with a polyol to form a reactive, isocyanate-terminated prepolymer.

DE 41 36 490 A1 relates to low-migration, solventless two-component coating, sealing and adhesive systems of polyols and isocyanate prepolymers. The NCO prepolymers are produced by reaction of polyol mixtures having a mean functionality of 2.05 to 2.5 with at least 90 mol-% secondary hydroxyl groups and diisocyanates containing isocyanate groups differing in their reactivity, the ratio of isocyanate to hydroxyl groups being 1.6 to 1.8:1. Table 1 on page 5 shows that MDI prepolymers produced in accordance with the teaching of DE 4136490 A1 have a monomer content of more than 0.3%.

WO 03/006521 A1 describes reactive polyurethanes with an NCO content of 4 to 12% NCO and a content of monomeric asymmetrical diisocyanates of 0.01 to 0.3% which are obtainable by reaction of at least one monomeric asymmetrical diisocyanate having a molecular weight of 160 g/mol to 500 g/mol with at least one diol having a molecular weight of 60 g/mol to 2,000 g/mol, the ratio of isocyanate groups to hydroxyl groups being 1.05:1 to 2.0:1. The production process can be carried out without additional working up and purification steps. Reactive polyurethanes of this type are suitable for the production of reactive one- and two-component adhesive and sealing compounds, assembly foams, potting compounds and flexible, rigid and integral foams, which may optionally contain solvents, and as a component for the production of reactive hotmelt adhesives. A major advantage of these reactive polyurethanes over known reactive polyurethanes with a low monomeric diisocyanate content is said to be the absence of the secondary products normally formed during the thermal working up of reactive polyurethanes.

The use of polyurethanes often involves problems which, although on the one hand requiring the well-known favorable properties of isocyanate compounds, on the other hand make the presence of other functional groups leading to crosslinking, particularly the presence of silyl groups, appear desirable, for example due to inadequate adhesion to certain substrates, such as glass or ceramics. The presence of silyl groups is also often required in the production of compositions for use in foams.

It is known from the prior art that silyl groups can be introduced into polyurethanes as reactive terminal groups. WO 99/48942 A1 describes polyurethanes which can be crosslinked or cured through one or more terminal alkoxysilyl groups and which still have excellent elasticity, flexibility and tear propagation resistance, even at low temperatures. These compounds can be produced by reaction of at least two component, a polyisocyanate or a mixtures of two or more polyisocyanates and a polyol or a mixture of two or more polyols, the polyol used being, for example, a polyether with a molecular weight (Mₙ) of at least 4,000 and a polydispersity PD (M_{w}/Mₙ) of les than 1.5 or an OH functionality of about 1.8 to about 2.0. The problem with the compositions mentioned in the document in question is, for example, that, because unsubstituted aminosilanes are added, compounds carrying the silyl groups in the middle rather than at the end of the chain are formed during the production process.

Accordingly, there is a still a need for reactive polyurethanes with a low monomeric diisocyanate content which would be suitable both for use as reactive one- and two-component adhesives and sealants, more particularly for reactive hotmelt adhesives or laminating adhesives, and for the production of assembly foams, potting compounds and flexible, rigid and integral foams.

Accordingly, the problem addressed by the present invention was to provide polyurethanes which would have the advantages of the compositions known from the prior art, but none, or at least fewer, of their disadvantages. More particularly, a problem addressed by the present invention was to provide polyurethanes which would show excellent adhesion to a number of substrates. More particularly, a problem addressed by the present invention was to provide reactive polyurethanes bearing at least one silyl group for use as adhesives or sealants which would be substantially free from monomeric diisocyanates or which would have a minimal monomeric diisocyanate content. Ideally, the adhesives/sealants would be free from labeling obligations in all countries.

To achieve the low monomeric diisocyanate content, some elaborate and expensive purification steps are carried out in the prior art. Actual examples include the removal of excess monomeric diisocyanates by selective extraction, for example with supercritical carbon dioxide, thin-layer distillation, thin-layer evaporation and precipitation of the reactive polyurethane from the reaction mixture with monomeric diisocyanates. Accordingly, another problem addressed by the present invention was to provide reactive polyurethanes bearing at least one silyl group which would have a low monomeric diisocyanate content without the elaborate purification steps.

Another problem addressed by the present invention was to provide polyurethanes bearing at least one silyl group in which the ratio of NCO groups to silane groups could be controlled as required to give polyurethanes having desirable properties.

The problems addressed by the invention are solved by the polyurethanes bearing silyl groups which are described in more detailed in the following.

### DESCRIPTION OF THE INVENTION

Accordingly, the present invention relates to a composition at least containing a polyurethane bearing at least one isocyanate group and at least one polyurethane bearing a silyl group, the polymers containing at least two different types of urethane groups and, as the silyl group, a silyl group corresponding to general formula I: 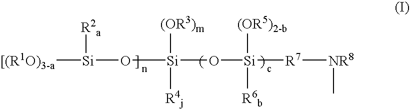
in which the substituents R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, R7 is an optionally substituted alkylene group containing 1 to about 44 carbon atoms, an optionally substituted cycloalkylene group containing 6 to about 24 carbon atoms or an optionally substituted arylene group containing 6 to about 24 carbon atoms, n, m and j are each integers of 0 to 3 (m+n+j=3), a is an integer of 0 to 3, b is an integer of 0 to 2 and c is a number of 0 to 8 and R⁸ is a linear or branched, saturated or unsaturated C₁₋₂₄ alkyl group, a cycloalkyl, phenyl, tolyl, mesityl, trityl or 2,4,6-tri-tert.butyl phenyl group, the composition containing less than 0.1% by weight of monomeric isocyanates and the ratio of isocyanate groups to silyl groups being about 90:10 to about 10:90.

The term “polyurethane” in the context of the present invention applies to a compound of polyurethane structure which can be obtained in a selective single-stage or multi-stage polyurethane synthesis. A polyurethane in the context of the invention has two or more urethane groups. The term also encompasses any deviations from that structure arising out of the statistical nature of the polyaddition process.

A “silyl group” in the context of the present invention is understood to be a functional group corresponding to general formula I above, in which the substituents R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms, n, m and j are each integers of 0 to 3 (m+n+j=3), a is an integer of 0 to 3, b is an integer of 0 to 2 and c is a number of 0 to 8 and R⁸ is a linear or branched C₁₋₂₄ alkyl group, a cycloalkyl, more particularly cyclopentyl or cyclohexyl, group, a phenyl, tolyl, mesityl, trityl or 2,4,6-tri-tert.butyl phenyl group.

The term “composition” in the context of the present invention relates to a mixture of compounds obtained in a suitable process for the production of polyurethanes bearing silyl groups: A corresponding composition contains, for example, the above-described polyurethanes bearing silyl groups, any educts not reacted in the reaction and products formed by an incomplete reaction of the educts.

In a preferred embodiment of the present invention, a composition according to the invention can contain, for example, polyurethanes bearing only silyl groups as crosslinkable functional groups. In addition, a composition according to the invention can contain, for example, silyl groups and NCO groups as crosslinkable functional groups. A composition according to the invention can also contain, for example, polyurethanes bearing only NCO groups as crosslinkable functional groups.

In a preferred embodiment of the present invention, the ratio of NCO groups to silyl groups in a composition according to the invention is about 90:10 to about 10:90. Particularly suitable ratios are, for example, about 80:20 to about 20:80 or about 70:30 to about 30:70 or about 60:40 to about 40:60.

According to the invention a composition according to the invention contains at least one polyurethane with at least two different types of urethane groups. “Different types of urethane groups in the context of the present specification are understood to be urethane groups which have a different chemical environment. This means, for example, that different types of urethane groups are covalently bonded to different following groups. In practice, different types of urethane groups can be obtained in particular by using polyisocyanates bearing urethane groups differing in their reactivity. In a preferred embodiment of the present invention, the different types of urethane groups present in a polyurethane in a composition according to the invention are produced by using at least one asymmetrical polyisocyanate. The asymmetry of a corresponding polyisocyanate is reflected in particular in a different reactivity of the isocyanate groups in the polyisocyanate.

According to the present invention, the above-described composition at least containing at least one polyurethane bearing at least one silyl group or a corresponding polyurea and at least one polyurethane bearing at least one NCO group or a corresponding polyurea is used, for example, as part of a preparation.

Accordingly, the present invention also relates to a preparation which contains at least one polyurethane bearing at least one silyl group or at least one polyurea bearing at least one silyl group or a mixture of two or more thereof and at least one polyurethane bearing at least one NCO group or at least one polyurea bearing at least one NCO group or a mixture of two or more thereof and which is obtainable by reacting at least three components A, B and C,
a) component A being an asymmetrical diisocyanate or a mixture of two or more asymmetrical diisocyanates,
b) component B being a silane corresponding to general formula II: 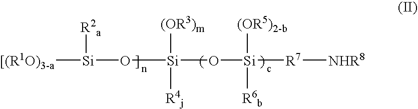
   in which the substituents R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms, n, m and j are each integers of 0 to 3 (m+n+j=3), a is an integer of 0 to 3, b is an integer of 0 to 2 and c is a number of 0 to 8 and R⁸ is a linear or branched C₁₋₁₀ alkyl group, a cycloalkyl, phenyl, tolyl, mesityl, trityl or 2,4,6-tri-tert.butyl phenyl group,
and
c) component C being a polyol or a mixture of two or more polyols or a polyamine or a mixture of two or more polyamines or a polyol and a mixture of two or more polyamines or a mixture of two or more polyols and a polyamine or a mixture of two or more polyols and a mixture of two or more polyols, the number ratio of NCO groups to silyl groups being 10:90 to 90:10.

According to the invention, a polyisocyanate, for example a diisocyanate, or a mixture of two or more polyisocyanates is used as component A. Polyisocyanates in the context of the invention are understood to be compounds which contain at least two isocyanate groups (NCO groups). For example, these are compounds with the general structure O═N═C-Z-C═N═O, where Z is an asymmetrical, linear or branched aliphatic, alicyclic or aromatic hydrocarbon radical which may optionally contain other inert substituents or substituents participating in the reaction.

Monomeric asymmetrical diisocyanates in the context of the present invention are, basically, aromatic, aliphatic or cycloaliphatic diisocyanates which can be obtained in the synthesis of isocyanates. For example, monomeric asymmetrical diisocyanates in the context of the present invention can be compounds with a molecular weight of 160 g/mol to 500 g/mol which contain NCO groups differing in their reactivity to NCO groups to form a covalent bond between reactive functional groups. However, monomeric asymmetrical isocyanates in the context of the invention may also be compounds with a molecular weight of more than 500 g/mol, for example compounds formed in the dimerization, trimerization, oligomerization or polymerization of isocyanates, for example NCO-group-containing allophanates or isocyanurates or polymeric isocyanates, such as polymer-MDI.

Basically, the differing reactivity of the NCO groups of the diisocyanates is attributable to a different chemical environment in which the NCO groups find themselves, for example to differently adjacent substituents to the NCO groups in the molecule which reduce the reactivity of one NCO group compared to the other NCO group, for example through steric shielding, and/or to different binding of an NCO group to the rest of the molecule, for example in the form of a primary or secondary NCO group.

Examples of suitable aromatic asymmetrical diisocyanates are any isomers of toluene diisocyanate (TDI) either in pure isomer form or as a mixture of several isomers, diphenylmethane-2,4′-diisocyanate (MDI) and mixtures of 4,4′-diphenylmethane diisocyanate with the 2,4′-MDI isomers.

Examples of suitable cycloaliphatic asymmetrical diisocyanates include 1-isocyanatomethyl-3-isocyanato-1,5,5-trimethylcyclohexane (isophorone diisocyanate, IPDI), 1-methyl-2,4-diisocyanatocyclohexane or hydrogenation products of the aromatic diisocyanates mentioned above, more particularly hydrogenated MDI in pure isomer form, preferably hydrogenated 2,4′-MDI.

Examples of aliphatic asymmetrical diisocyanates are 1,6-diisocyanato-2,2,4-trimethylhexane, 1,6-diisocyanato-2,4,4-trimethylhexane and lysine diisocyanate.

In a particularly preferred embodiment of the invention, TDI or 2,4-TDI or polymer-MDI or a mixture of two or more thereof is used as the monomeric asymmetrical diisocyanate.

In another embodiment of the present invention, the different types of urethane groups or the different types of urea groups are produced by using at least one polyisocyanate containing at least two isocyanate groups of which the reactivity to an isocyanate-reactive functional group differs by at least a factor of 1.1, for example by at least a factor of 1.2, 1.3, 1.4, 1.5 or more.

In the production of the compositions according to the invention, component B is a silane corresponding to general formula II: 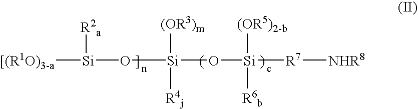
in which the substituents R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms, n, m and j are each integers of 0 to 3 (m+n+j=3), a is an integer of 0 to 3, b is an integer of 0 to 2 and c is a number of 0 to 8 and R⁸ is a linear or branched C₁₋₂₄ alkyl group, a cycloalkyl, phenyl, tolyl, mesityl, trityl or 2,4,6-tri-tert.butyl phenyl group.

Basically, any compounds corresponding to the general formula are suitable for the production of the polyurethanes according to the invention. However, in the interests of adequate reactivity of the silyl groups, the following compounds have proved to be advantageous, the compounds mentioned having to carry a substituent at the N atom selected from the group consisting of a linear or branched C₁₋₂₄ alkyl group, a cyclopentyl, cyclohexyl, phenyl, tolyl, mesityl, trityl or 2,4,6-tri-tert.butylphenyl group where this is not already apparent from the name of the compound itself: N-(α-methyldimethoxysilylmethyl)amine, N-(α-trimethoxysilylmethyl)amine, N-(α-diethylmethoxysilylmethyl)amine, N-(α-ethyidimethoxysilylmethyl)amine, N-(α-methyldiethoxysilylmethyl)amine, N-(α-triethoxysilylmethyl)amine, N-(α-ethyldiethoxysilylmethyl)amine, N-(β-methyldimethoxysilylethyl)amine, N-(β-trimethoxysilylethyl)amine, N-(β-ethyldimethoxysilylethyl)amine, N-(β-methyldiethoxysilylethyl)amine, N-(β-triethoxysilylethyl)amine, N-(β-ethyldiethoxysilylethyl)amine, N-(γ-methyldimethoxysilylpropyl)amine, N-(γ-trimethoxysilylpropyl)amine, N-(γ-ethyidimethoxysilylpropyl)amine, N-(γ-methyrdiethoxysilylpropyl)amine, N-(γ-triethoxysilylpropyl)amine, N-(γ-ethyldiethoxysilylpropyl)amine, N-(4-methyldimethoxysilylbutyl)amine, N-(4-trimethoxysilylbutyl)amine, N-(4-triethylsilylbutyl)amine, N-(4-diethylmethoxysilylbutyl)amine, N-(4-ethyldimethoxysilylbutyl)amine, N-(4-methyldiethoxysilylbutyl)amine, N-(4-triethoxysilylbutyl)amine, N-(4-diethylethoxysilylbutyl)amine, N-(4-ethyldiethoxysilylbutyl)amine, N-(5-methyldimethoxysilylpentyl)amine, N-(5-trimethoxysilylpentyl)amine, N-5-triethylsilylpentyl)amine, N-(5-ethyidimethoxysilylpentyl)amine, N-(5-methyldiethoxysilylpentyl)amine, N-(5-triethoxysilylpentyl)amine, N-(5-diethylethoxysilylpentyl)amine, N-(5-ethyldiethoxysilylpentyl)amine, N-(6-methyldimethoxysilylhexyl)amine, N-(6-trimethoxysilylhexyl)amine, N-(6-ethyldimethoxysilylhexyl)amine, N-(6-methyidiethoxysilylhexyl)amine, N-(6-triethoxysilylhexyl)amine, N-(6-ethyldiethoxysilylhexyl)amine, N-[γ-tris-(trimethoxysiloxy)silylpropyl]amine, N-[γ-tris-(trimethoxysiloxy)silylpropyl]amine, N-(γ-trimethoxysiloxydimethylsilylpropyl)amine, N-(γ-trimethylsiloxydimethoxysilylpropyl)amine, N-(γ-triethoxysiloxydiethylpropyl)amine, N-(γ-triethoxysiloxydiethoxysilylpropyl)mine, N,N-butyl-(γ-trimethoxysilylpropyl)amine, N,N-butyl-(γ-triethoxysilylpropyl)amine, N,N-phenyl-(γ-trimethoxysilylpropyl)amine, N,N-phenyl-(γ-triethoxysilylpropyl)amine, N,N-cyclohexyl-(γ-trimethoxysilylpropyl)amine, N,N-ethyl-(γ-trimethoxysilylpropyl)amine, diethyl-N-(trimethoxysilylpropyl)aspartate, diethyl-N-(triethoxysilylpropyl)aspartate, N,N-ethyl-(γ-dimethoxymethylsilypropyl)amine, N,N-ethyl-(γ-trimethoxysilylisobutyl)amine, N,N-bis-(trimethoxypropyl)amine, N,N-ethyl-(γ-trimethoxysilylisobutyl)amine, N,N-ethyl-(α-trimethoxysilylmethyl)amine, dibutyl-N-(trimethoxysilylpropyl)aspartate, dibutyl-N-(triethoxysilylpropyl)aspartate, N,N-(β-aminopropyl)-(γ-trimethoxysilylpropyl)amine, N,N-di-(trimethoxysilylpropyl)ethylenediamine, tetra-(trimethoxysilylpropyl)ethylenediamine and N,N-ethyl-(β-trimethoxysilylethyl)amine or N-[γ-tris(trimethylsiloxy)silylpropyl]amine or N,N-cyclohexyl-α-triethoxysilylmethylamine or N,N-cyclohexyl-α-methyldiethoxysilylmethylamine or N,N-phenyl-α-trimethoxysilylmethylamine or N,N-phenyl-α-methyldimethoxysilylmethylamine or mixtures of two or more thereof.

Compounds which contain at least one methoxy or ethoxy group at the silicon atom are preferably used as component B, compounds containing two or three methoxy groups or two or three ethoxy groups or mixtures of methoxy and ethoxy groups being particularly preferred.

A composition according to the invention may be obtained, for example, simply by reacting components A and B in suitable ratios. However, it is a feature of the invention and of advantage so far as the properties of the compositions and the preparations produced from them are concerned that at least one compound is used in the production of the compositions which is polyfunctional in its reactivity to NCO groups, preferably containing two or three NCO-reactive groups. Suitable NCO-reactive groups are, for example, OH groups, COOH groups, amino groups or mercapto groups. Polyols or polyamines are particularly suitable for the purposes of the invention. Accordingly, it has been found to be of advantage to use a polyol or a mixture of two or more polyols or a polyamine or a mixture of two or more polyamines or a polyol and a mixture of two or more polyamines or a mixture of two or more polyols and a polyamine or a mixture of two or more polyols and a mixture of two or more polyols as component C in the production of a composition according to the invention or a preparation according to the invention.

Accordingly, a polyol or a mixture of two or more polyols, for example, is used as component C in the production of the compositions according to the invention.

In the context of the present invention, the term “polyol” stands for a compound which contains at least two OH groups, irrespective of whether the compound contains other functional groups. However, a polyol used in accordance with the present invention preferably contains only OH groups as functional groups or, if other functional groups are present, none of these other functional groups is reactive at least to isocyanates under the conditions prevailing during the reaction of components A and B.

The polyols suitable as component C are, for example, polyesterpolyols which are known, for example, from Ullmanns Enzyklopädie der technischen Chemie, 4th Edition, Vol. 19, pp. 62-65. Preferred polyester polyols are obtained by reaction of dihydric alcohols with polybasic, preferably dibasic polycarboxylic acids. The polycarboxylic acids may be aliphatic, cycloaliphatic, araliphatic, aromatic or heterocyclic and may optionally be substituted, for example by halogen atoms, and/or unsaturated. Examples of such polycarboxylic acids are suberic acid, azelaic acid, phthalic acid, isophthalic acid, phthalic anhydride, hexahydrophthalic anhydride, tetrachlorophthalic anhydride, endomethylenetetrahydrophthalic anhydride, glutaric anhydride, maleic acid, maleic anhydride, fumaric acid and/or dimeric fatty acids.

The polycarboxylic acids mentioned may be used either individually as sole acid component or in admixture with one another for the synthesis of component C. Preferred carboxylic acids correspond to the general formula HOOC—(CH₂)_{y}—COOH, where y is a number of 1 to 20, preferably an integer of 2 to 20, for example succinic acid, adipic acid, dodecanedicarboxylic acid and sebacic acid. Instead of the free polycarboxylic acids, the corresponding polycarboxylic anhydrides or corresponding polycarboxylic acid esters of lower alcohols or mixtures thereof may also be used for the production of the polyester polyols.

Suitable polyhydric alcohols for reaction with the polycarboxylic acid component for the synthesis of component C are, for example, ethylene glycol, propane-1,2-diol, propane-1,3-diol, butane-1,3-diol, butene-1,4-diol, butine-1,4-diol, pentane-1,5-diol, hexane-1,6-diol, neopentyl glycol, bis-(hydroxymethyl)-cyclohexane, such as 1,4-bis-(hydroxymethyl)-cyclohexane, 2-methylpropane-1,3-diol, methyl pentanediols, also diethylene glycol, triethylene glycol, tetraethylene glycol, polyethylene glycol, dipropylene glycol, polypropylene glycols, dibutylene glycol and polybutylene glycol. Preferred polyhydric alcohols are neopentyl glycol and alcohols with the general formula HO—(CH₂)ₓ—OH, where x is a number of 1 to 20, preferably an integer of 2 to 20. Examples of such alcohols are ethylene glycol, butane-1,4-diol, hexane-1,6-diol, octane-1,8-diol and dodecane-1,12-diol.

Also suitable as component C are polycarbonate diols which may be obtained, for example, by reacting phosgene with an excess of the low molecular weight alcohols mentioned as synthesis components for the polyester polyols.

Lactone-based polyester diols are also suitable as component C. Lactone-based polyester diols are homopolymers or copolymers of lactones, preferably hydroxyl-terminated products of the addition of lactones onto suitable difunctional starter molecules. Examples of suitable lactones are ε-caprolactone, β-propiolactone, γ-butyrolactone and/or methyl-ε-caprolactone and mixtures thereof. Suitable starter components are, for example, the low molecular weight dihydric alcohols mentioned above as synthesis component for the polyester polyols. Low molecular weight polyester diols or polyether diols may also be used as starters for the production of the lactone polymers instead of the lactone polymers, the corresponding chemically equivalent polycondensates of the hydroxycarboxylic acids corresponding to the lactones may also be used. The polyester polyols may also be synthesized with the assistance of small quantities of monofunctional monomers and/or monomers of higher functionality. Also suitable as component C are polyacrylates containing OH groups which may be obtained, for example, by the polymerization of ethylenically unsaturated monomers containing an OH group. Such monomers are obtainable, for example, by the esterification of ethylenically unsaturated carboxylic acids and dihydric alcohols, the alcohol generally being present in a slight excess. Ethylenically unsaturated carboxylic acids suitable for this purpose are, for example, acrylic acid, methacrylic acid, crotonic acid or maleic acid. Corresponding OH-functional esters are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

In addition, polyether diols may be used as component C. They may be obtained in particular by polymerization of propylene oxide, butylene oxide, tetrahydrofuran, styrene oxide or epichlorohydrin on their own, for example in the presence of BF₃, or by addition of these compounds—optionally in admixture or successively—onto starter components containing reactive hydrogen atoms, such as water, alcohols or amines, for example propane-1,2-diol, propane-1,3-diol, 1,2-bis-(4-hydroxydiphenyl)-propane or aniline.

Alcohols with a functionality of more than two may be used in small quantities both for the production of the polyester polyols and for the production of the polyether polyols. More particularly, compounds such as these are, for example, trimethylolpropane, pentaerythritol, glycerol, sugars, such as glucose for example, oligomerized polyols such as, for example, dimeric or trimeric ethers of trimethylolpropane, glycerol or pentaerythritol, partly esterified polyhydric alcohols corresponding to the formula shown above, such as for example partly esterified trimethylolpropane, partly esterified glycerol, partly esterified pentaerythritol, partly esterified polyglycerol and the like, monobasic aliphatic carboxylic acids preferably being used for esterification. The hydroxyl groups of the polyols may optionally be etherified by reaction with alkylene oxides. The above-mentioned compounds are also suitable as starter components for the synthesis of the polyether polyols. The polyol compounds with a functionality of >2 are preferably used in only small quantities for the synthesis of the polyester polyols or polyether polyols.

Polyhydroxyolefins, preferably those containing two terminal hydroxyl groups, for example α,ω-dihydroxypolybutadiene, α,ω-dihydroxypolymethacrylates or α,ω-dihydroxypolyacrylates, are also suitable for use as component C.

The other polyols used also include the above-mentioned short-chain alkanediols, preferably neopentyl glycol and the unbranched C₂₋₁₂ diols, for example propylene glycol, butane-1,4-diol, pentane-1,5-diol or hexane-1,6-diol. The polyols listed above may also be used in the form of mixtures in any ratio for the purposes of the invention.

Other suitable polyols are dihydric or polyhydric compounds which contain at least one primary or secondary amino group or—where more than one amino group per molecule is present—both primary and secondary amino groups. Besides the amino groups, the corresponding amine compounds of component C may contain other functional groups, more particularly isocyanate-reactive groups. These include, in particular, the hydroxyl group or the mercapto group. The compounds suitable for use as polyol in accordance with the invention include, for example, monoaminoalcohols containing an aliphatically bound hydroxyl group, such as ethanolamine, N-methylethanolamine, N-ethylethanolamine, N-butylethanolamine, N-cyclohexylethanolamine, N-tert.butyl ethanolamine, leucinol, isoleucinol, valinol, prolinol, hydroxyethyl aniline, 2-(hydroxymethyl)-piperidine, 3-(hydroxymethyl)-piperidine, 2-(2-hydroxyethyl)-piperidine, 2-amino-2-phenylethanol, 2-amino-1-phenylethanol, ephedrine, p-hydroxyephedrine, norephedrine, adrenalin, noradrenalin, serine, isoserine, phenylserine, 1,2-diphenyl-2-aminoethanol, 3-amino-1-propanol, 2-amino-1-propanol, 2-amino-2-methyl-1-propanol, isopropanolamine, N-ethyl isopropanolamine, 2-amino-3-phenylpropanol, 4-amino-1-butanol, 2-amino-1-butanol, 2-aminoisobutanol, neopentanolamine, 2-amino-1-pentanol, 5-amino-1-pentanol, 2-ethyl-2-butyl-5-aminopentanol, 6-amino-1-hexanol, 2-amino-1-hexanol, 2-(2-aminoethoxy)-ethanol, 3-(aminomethyl)-3,5,5-trimethyl cyclohexanol, 2-aminobenzyl alcohol, 3-aminobenzyl alcohol, 3-amino-5-methyl benzyl alcohol, 2-amino-3-methyl benzyl alcohol.

If component C is to be used, for example, to produce chain branches, it is possible, for example, to use monoaminopolyols containing two aliphatically bound hydroxyl groups, such as 1-aminopropane-2,3-diol, 2-aminopropane-1,3-diol, 2-amino-2-methylpropane-1,3-diol, 2-amino-2-ethylpropane-1,3-diol, 2-amino-1-phenylpropane-1,3-diol, diethanolamine, diisopropanolamine, 3-(2-hydroxyethylamino)-propanol and N-(3-hydroxypropyl)-3-hydroxγ-2,2-dimethyl-1-amino groups.

Polyamines may also be used as component C. Examples of suitable polyamines include such compounds as hydrazine, ethylenediamine, 1,2- and 1,3-propylenediamine, butylenediamines, pentamethylenediamines, hexamethylenediamines such as, for example, 1,6-hexamethylenediamine, alkyl hexamethylenediamines such as, for example, 2,4-dimethyl hexamethylenediamine, generally alkylenediamines containing up to about 44 carbon atoms, including cyclic or polycyclic alkylenediamines which may be obtained, for example, from the dimerization products of unsaturated fatty acids in known manner. Also usable, but not preferred, are aromatic diamines such as, for example, 1,2-phenylenediamine, 1,3-phenylenediamine or 1,4-phenylenediamine. Higher amines such as, for example, diethylenetriamine, aminomethyl diamino-1,8-octane and triethylenetetramine may also be used in accordance with the invention.

According to the invention, the polyurethanes present in a composition according to the invention or in a preparation according to the invention must contain both NCO groups and silyl groups. It is only through the presence of both types of functional groups that the advantages according to the invention can be obtained.

The ratio of NCO groups to silyl groups is in the range from 90:10 to 10:90, these figures relating to the number ratio between the functional groups. In another embodiment, the figures in question may also relate to the ratio by weight between the functional groups.

In another preferred embodiment of the invention, the ratio of NCO groups to silyl groups is in the range from about 90:10 to about 60:40 or about 80:20 to about 70:30.

The present invention also relates to preparations containing a composition according to the invention, as described herein, and at least one other additive. Accordingly, a preparation according to the invention contains a composition according to the invention and one or more compounds selected from the group consisting of plasticizers, reactive diluents, antioxidants, catalysts, hardeners, fillers, tackifiers, drying agents and UV stabilizers.

In the context of the proposed uses according to the invention, a composition according to the invention may be put to its final use in the form hitherto described. In general, however, the composition according to the invention is -advantageously used in a preparation which contains other compounds, for example for adjusting viscosity or the material properties of the composition.

For example, the viscosity of the composition according to the invention may be too high for certain applications. However, it has been found that the viscosity of the polyurethane according to the invention can generally be simply and conveniently reduced by using a “reactive diluent” without any significant adverse effect on the material properties of the cured composition.

The reactive diluent preferably contains at least one functional group which is capable under the influence of moisture of entering into a chain-extending or crosslinking reaction with a reactive group of the first polyurethane according to the invention (reactive diluent). The at least one functional group may be any functional group capable of reacting by crosslinking or chain extension under the influence of moisture.

Suitable reactive diluents are any polymeric compounds which are miscible with the first polyurethane according to the invention and reduce its viscosity and which have hardly any effect on the material properties of the product formed after curing or crosslinking or at least do not adversely affect them to such an extent that the product becomes unusable. Suitable reactive diluents are, for example, polyesters, polyethers, polymers of compounds containing an olefinically unsaturated double bond or polyurethanes providing the requirements mentioned above are satisfied.

However, the reactive diluents are preferably polyurethanes containing at least one alkoxysilane group as reactive group.

The reactive diluents may contain one or more functional groups although the number of functional groups is preferably between 1 and about 6 and more preferably between about 2 and about 4, for example about 3.

In one preferred embodiment, the viscosity of the reactive diluents is below about 20,000 mPas and, more particularly, in the range from about 1,000 to about 10,000, for example about 3,000 to about 6,000 mPas (Brookfield RVT, 23° C., spindle 7, 2.5 r.p.m.).

The reactive diluents suitable for use in the process according to the invention may have any molecular weight distribution (PD) and, accordingly, can be produced by any of the methods typically used in polymer chemistry.

Polyurethanes which can be produced from a polyol component and an isocyanate component, followed by functionalization with one or more alkoxysilyl groups, are preferably used as the reactive diluents.

In the context of the present invention, the term “polyol component” encompasses an individual polyol or a mixture of two or more polyols which may be used for the production of polyurethanes. A polyol is understood to be a polyhydric alcohol, i.e. a compound containing more than one OH group in the molecule such as already described herein as component C.

A number of polyols may be used as the polyol component for producing the reactive diluent. They include, for example, aliphatic alcohols containing 2 to 4 OH groups per molecule. The OH groups may be both primary and secondary. Suitable aliphatic alcohols include, for example, ethylene glycol, propylene glycol and the same polyhydric alcohols as have already been mentioned in the present specification.

Polyethers which have been modified by vinyl polymers are also suitable for use as the polyol component. Products such as these are obtainable, for example, by polymerizing styrene and/or acrylonitrile in the presence of polyethers.

Polyester polyols with a molecular weight of about 200 to about 5,000 are also suitable as polyol component for the production of the reactive diluent. For example, polyester polyols obtainable by the above-described reaction of low molecular weight alcohols, more particularly ethylene glycol, diethylene glycol, neopentyl glycol, hexanediol, butanediol, propylene glycol, glycerol or trimethylol propane, with caprolactone may be used. As already mentioned, other polyhydric alcohols suitable for the production of polyester polyols are 1,4-hydroxymethyl cyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol.

As described above, other suitable polyester polyols can be obtained by polycondensation. Thus, dihydric and/or trihydric alcohols can be condensed with less than the equivalent quantity of dicarboxylic acids and/or tricarboxylic acids or reactive derivatives thereof to form polyester polyols. Suitable dicarboxylic acids and tricarboxylic acids and suitable alcohols were mentioned in the foregoing.

According to the invention, polyols used with particular preference as the polyol component for producing the reactive diluents are, for example, dipropylene glycol and/or polypropylene glycol with a molecular weight of about 400 to about 2,500 and polyester polyols, preferably polyester polyols obtainable by polycondensation of hexanediol, ethylene glycol, diethylene glycol or neopentyl glycol or mixtures of two or more thereof and isophthalic acid or adipic acid or mixtures thereof.

Another suitable polyol component for producing the reactive diluents are polyacetals. Polyacetals are compounds obtainable from glycols, for example diethylene glycol or -hexanediol, with formaldehyde. Polyacetals suitable for use in accordance with the present invention may also be obtained by the polymerization of cyclic acetals.

Polycarbonates are also suitable as polyols for producing the reactive diluents. Polycarbonates may be obtained, for example, by reaction of diols, such as propylene glycol, butane-1,4-diol or hexane-1,6-diol, diethylene glycol, triethylene glycol or tetraethylene glycol or mixtures of two or more thereof, with diaryl carbonates, for example, diphenyl carbonate, or phosgene.

Polyacrylates containing OH groups are also suitable as polyol component for producing the reactive diluents. These polyacrylates may be obtained, for example, by the polymerization of ethylenically unsaturated monomers containing an OH group. Such monomers are obtainable, for example, by the esterification of ethylenically unsaturated carboxylic acids and dihydric alcohols, the alcohol generally being present in a slight excess. Ethylenically unsaturated carboxylic acids suitable for this purpose are, for example, acrylic acid, methacrylic acid, crotonic acid or maleic acid. Corresponding OH-functional esters are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

To produce the preferred reactive diluents according to the invention, the corresponding polyol component is reacted with an at least difunctional isocyanate. Basically, the at least difunctional isocyanate used may be any isocyanate containing at least two isocyanate groups, although compounds containing two to four isocyanate groups and more particularly two isocyanate groups are preferred for the purposes of the invention. The polyisocyanates mentioned above are particularly suitable for the production of the reactive diluents.

The compound present as reactive diluent in accordance with the present invention preferably contains at least one alkoxysilane group, preferred alkoxysilane groups being dialkoxy and trialkoxysilane groups.

Under certain conditions, it can be of advantage for the functional groups of the reactive diluent to differ in their reactivity to moisture or to the particular hardener used from the functional groups of the first polyurethane with the higher molecular weight.

The preparation according to the invention contains the polyurethane according to the invention or a mixture of two or more polyurethanes according to the invention and the reactive diluent or a mixture of two-or more reactive diluents in general in such a ratio that the preparation has a viscosity of at most 200,000 mPas (Brookfield RVT, 23° C., spindle 7, 2.5 r.p.m.). A percentage content of reactive diluent (including a mixture of two or more reactive diluents), based on the preparation as a whole, of about 1% by weight to about 70% by weight and, more particularly, about 5% by weight to about 25% by weight is generally suitable for this purpose.

Instead of or in addition to. a reactive diluent, a plasticizer may also be used to reduce the viscosity of the polyurethane-according to the invention.

“Plasticizers” in the context of the present invention are compounds which generally reduce the viscosity of a preparation containing a polyurethane according to the invention or a mixture of two or more polyurethanes according to the invention.

Examples of plasticizers are esters, such as abietic acid esters, adipic acid esters, azelaic acid esters, benzoic acid esters, butyric acid esters, acetic acid esters, esters of higher fatty acids containing about 8 to about 44 carbon atoms, esters of OH-functional or epoxidized fatty acids, fatty acid esters and fats, glycolic acid esters, phosphoric acid esters, phthalic acid esters of linear or branched C₁₋₁₂ alcohols, propionic acid esters, sebacic acid esters, sulfonic acid esters, thiobutyric acid esters, trimellitic acid esters, citric acid esters and nitrocellulose- and polyvinyl acetate-based esters and mixtures of two or more thereof. The asymmetrical esters of dibasic aliphatic dicarboxylic acids, for example the esterification product of adipic acid monooctyl ester with 2-ethylhexanol (Edenol DOA, a product of Henkel, Düsseldorf), are particularly suitable.

Other suitable plasticizers are the pure or mixed ethers of monohydric, linear or branched C₄₋₁₆ alcohols or mixtures of two or more different ethers of such alcohols, for example dioctyl ethers (obtainable as Cetiol OE, a product of Henkel, Düsseldorf).

Further examples of plasticizers are end-capped polyethylene glycols, such as polyethylene or polypropylene glycol di-C₁₋₄-alkyl ethers, more particularly the dimethyl or diethyl ether of diethylene glycol or dipropylene glycol, and mixtures of two or more thereof.

According to the invention, diurethanes are also suitable plasticizers. Diurethanes may be obtained, for example, by reaction of OH-terminated diols with monofunctional isocyanates, the stoichiometry being selected so that substantially all free OH groups react off. Any excess isocyanate may then be removed from the reaction mixture, for example by distillation. Another method of producing diurethanes comprises reacting monohydric alcohols with diisocyanates, all the NCO groups reacting off.

The plasticizer is generally used in a quantity of about 1 to about 20% by weight, based on the preparation, preferably in a quantity of 3 to 15% by weight and more particularly in a quantity of 8 to 12% by weight.

Besides plasticizers, the preparation according to the invention may contain other additives which are generally intended to modify certain material properties of the preparation before or after processing or which promote the stability of the preparation before or after processing.

Accordingly, the present invention also relates to a preparation containing a silanized polyurethane according to the invention or-a mixture of two or more thereof and a plasticizer and one or more compounds selected from the group consisting of antioxidants, catalysts, tackifiers, fillers and UV stabilizers.

The antioxidants are used in a quantity of up to 7% by weight and more particularly in a quantity of about 2 to 5% by weight.

The preparation according to the invention may additionally contain up to 5% by weight catalysts to control the cure rate. Suitable catalysts are, for example, suitable catalysts are, for example, organometallic compounds, such as iron or tin compounds, more particularly the 1,3-dicarbonyl compounds of iron or divalent or tetravalent tin, more particularly Sn(II) carboxylates and dialkyl Sn(IV) dicarboxylates or the corresponding dialkoxylates, for example dibutyl tin dilaurate, dibutyl tin diacetate, dioctyl tin diacetate, dibutyl tin maleate, tin(II) octoate, tin(II) phenolate and the acetyl acetonates of divalent and tetravalent tin.

If it is to be used as an adhesive, the preparation according to the invention may contain up to about 30% by weight of typical tackifiers. Suitable tackifiers are, for example, resins, terpene oligomers, coumarone/indene resins, aliphatic petrochemical resins and modified phenolic resins.

The preparation according to the invention may additionally contain up to about 80% by weight of fillers. Suitable fillers are, for example, inert inorganic compounds, such as chalk, lime flour, precipitated silica, pyrogenic silica, zeolites, bentonites, ground minerals, glass beads, glass powder, glass fibers and chopped strands and other inorganic and organic fillers known to the expert, more particularly short-staple fibers or hollow plastic beads. Fillers which make the preparation thixotropic, for example swellable plastics, such as PVC, may also be used.

The preparation according to the invention may contain up to about 2% by weight and preferably about 1% by weight of UV stabilizers. Suitable UV stabilizers are the so-called hindered amine light stabilizers (HALS). A preferred embodiment of the invention is characterized by the use of a UV stabilizer which carries a silane group and which is incorporated in the end product during crosslinking or curing.

The products Lowilite 75 and Lowilite 77 (Great Lakes, USA) are particularly suitable for this purpose.

In many cases, it is appropriate to stabilize the preparations according to the invention against penetrating moisture with drying agents in order further to increase their shelf life.

Such an improvement in shelf life can be obtained, for example, by using drying agents. Suitable drying agents are any compounds which react with water to form a group inert to the reactive groups present in the preparation, but which at the same time undergo only minimal changes in their molecular weight. In addition, the reactivity of the drying agents to moisture which has penetrated into the preparation must be higher than the reactivity of the terminal groups of the polyurethane or polyurea according to the invention present in the preparation or the mixture of two or more such polyurethanes or two or more polyureas of the mixture of a polyurethane and two or more polyureas or the mixture of two or more polyurethanes and a polyurea or the mixture of two or more polyurethanes and two or more polyureas.

Suitable drying agents are, for example, isocyanates.

In one preferred embodiment, however, the drying agents used are silanes, for example vinyl silanes, such as 3-vinylpropyl triethoxysilane, oxime silanes, such as methyl-O,O′,O″-butan-2-one trioxime silane or O,O′,O″,O′″-butan-2-one tetraoxime silane (CAS No. 022984-54-9 and 034206-40-1), or benzamidosilanes, such as bis-(N-methylbenzamido)-methyl ethoxysilane (CAS No. 16230-35-6) or carbamatosilanes, such as carbamatomethyl trimethoxysilane.

Other suitable drying agents are the above-mentioned reactive diluents providing they have a molecular weight (Mₙ) of less than about 5,000 and contain terminal groups of which the reactivity to moisture which has penetrated into the preparation is at least as high as and preferably higher than the reactivity of the reactive groups of the polyurethane according to the invention.

The preparation according to the invention generally contains about 0 to about 6% by weight of drying agents.

In principle, the compositions according to the invention may be produced by any processes known to the expert. However, the processes described in the following are particularly suitable.

The present invention relates to a process for the production of compositions which contain at least one polyurethane bearing at least one silyl group by reacting
a) at least one asymmetrical diisocyanate as component A with
b) at least one silane corresponding to general formula II: 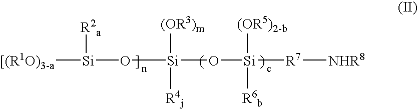
   in which the substituents R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms or an aryl group containing 6 to about 24 carbon atoms, R⁷ is an optionally substituted alkylene group containing 1 to about 44 carbon atoms, an optionally substituted cycloalkylene group containing 6 to about 24 carbon atoms or an optionally substituted arylene group containing 6 to about 24 carbon atoms, n, m and j are each integers of 0 to 3 (m+n+j=3), a is an integer of 0 to 3, b is an integer of 0 to 2 and c is a number of 0 to 8 and R⁸ is a linear or branched C₁₋₂₄ alkyl group, a cycloalkyl, phenyl, tolyl, mesityl, trityl or 2,4,6-tri-tert.butyl phenyl group, as component B
and
c) optionally a polyol or a mixture of two or more polyols or a polyamine or a mixture of two or more polyamines or a polyol and a mixture of two or more polyamines or a mixture of two or more polyols and a polyamine or a mixture of two or more polyols and a mixture of two or more polyols as component C,
   the number ratio of NCO groups to silane groups in the final composition being 10:90 to 90:10.

In principle, the reaction may be carried out in a single step although, in a particularly advantageous embodiment of the invention, the reaction is carried out in at least two steps.

In a first step, at least one monomeric asymmetrical diisocyanate is preferably reacted with at least one polyol or polyamine or a mixture thereof, as described in detail in the foregoing as component C, to form a compound containing at least one isocyanate group or a mixture of two or more such compounds and, in a following step, this compound is reacted with at least one silane corresponding to general formula II.

The reaction of component C with component A may be carried out by any method known to the expert under the general rules of polyurethane production. For example, the reaction may be carried out in the presence of a solvent. Basically, suitable solvents are any of the solvents typically used in polyurethane chemistry, more particularly esters, ketones, halogenated hydrocarbons, alkanes, alkenes and aromatic hydrocarbons. Examples of such solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethylketone, diisobutyl ketone, dioxane, ethyl acetate, ethylene glycol monobutyl ether acetate, ethylene glycol monoethyl acetate, 2-ethylhexyl acetate, glycol diacetate, heptane, hexane, isobutyl acetate, isooctane, isopropyl acetate, methyl ethyl ketone, tetrahydrofuran or tetrachloroethylene or mixtures of two or more of the solvents mentioned.

If the reaction components themselves are liquid or if at least one or more of the reaction components form a solution or dispersion of other, insufficiently liquid reaction components, there is no need at all to use solvents. Such a solventless reaction represents a preferred embodiment of the invention.

To carry out the process according to the invention, component C is introduced into a suitable vessel, optionally together with a suitable solvent, and dried. The asymmetrical diisocyanate is then added. To accelerate the reaction, the temperature is usually increased to about 40-80° C.

The reaction is normally carried out using a catalyst, particularly when a polyol or a mixture of two or more polyols is used as a reactant.

Catalysts typically used in the production of polyurethanes in this way include, for example, strongly basic amides, such as 2,3-dimethyl-3,4,5,6-tetrahydropyrimidine, tris-(dialkylaminoalkyl)-s-hexahydrotriazines, for example tris-(N,N-dimethylaminopropyl)-s-hexahydrotriazine or the usual tertiary amines, for example triethylamine, tributylamine, dimethylbenzylamine, N-ethyl-, N-methyl-, N-cyclohexylmorpholine, dimethylcyclohexylamine, dimorpholinodiethylether, 2-(dimethylaminoethoxy)-ethanol, 1,4-diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane and the like and organometallic compounds, such as titanic acid esters, iron compounds, for example iron(III) acetyl acetonate, tin compounds, for example tin(II) salts of organic carboxylic acids, for example tin(II) diacetate, the tin(II) salt of 2-ethylhexanoic acid (tin(II) octoate), tin(II) dilaurate or the dialkyltin(IV) salts of organic carboxylic acids, for example dibutyltin(IV) diacetate, dibutyltin(IV) dilaurate, dibutyltin(IV) maleate or dioctyltin(IV) diacetate or the like, and dibutyltin(IV) dimercaptide or mixtures of two or more of the catalysts mentioned and synergistic combinations of strongly basic amines and organometallic compounds. The catalysts may be used in typical quantities, for example of about 0.002 to about 5% by weight, based on the polyalcohols.

Where it is desired to use a catalyst, the catalyst is generally added to the reaction mixture in a quantity of about 0.005% by weight or about 0.01 to about 0.2% by weight, based on the mixture as a whole.

The reaction time depends upon the polyol components used, the isocyanate component used, the reaction temperature and the catalyst present, if any. The total reaction time is normally about 30 minutes to about 20 hours.

The reaction is normally conducted in such a way that the ratio of NCO groups to NCO-reactive functional groups, for example OH groups or amino groups, is selected so that a prepolymer containing at least one NCO group is formed.

The reaction with the amines bearing silyl groups is then carried out in known manner. To this end, an NCO prepolymer is reacted, for example, with an aminosilane, optionally together with a suitable solvent, in a suitable vessel. The temperature is increased, for example, to about 40 to about 80° C. Catalysts may be added to accelerate the reaction.

The ratio of NCO groups to silyl groups in the educts is selected so that the desired final ratio of isocyanate groups to silyl groups is established on completion of the reaction.

The present invention also relates to the use of the compositions according to the invention or the preparations according to the invention for the production of reactive one- or two-component surface coating compositions, more particularly reactive one- or two-component adhesives or sealants, for the production of reactive hotmelt adhesives and solventless or solvent-based laminating adhesives and for the production of assembly foams, potting compounds and flexible, rigid and integral foams.

It is of particular advantage in this regard that a higher foam yield can be obtained in assembly foams than in the conventional silane foams. There is less foaming than in pure PU adhesives.

As used herein, and in particular as used herein to define the elements of the claims that follow, the articles “a” and “an” are synonymous and used interchangeably with “at least one” or “one or more,” disclosing- or-encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

The invention is illustrated by the following Examples.

### EXAMPLES

### Example 1

### Comparison

97 g polypropylene glycol 400 and 40.0 g tris-(monochloroisopropyl)-phosphate (flame retardant) were introduced into a 500 ml reaction flask equipped with stirring, cooling and heating means and, after addition of 0.1 g dibutyl tin laurate, were heated with stirring to 50° C. 63.0 g 2,4-TDI were added dropwise with stirring at 50° C., followed by stirring for 20 hours at 50° C. The low-viscosity product was stored under nitrogen in a moisture-proof glass vessel. A content of free TDI monomer of 0.3% was determined by GPC analysis.

### Example 2

97 g polypropylene glycol 400 and 40.0 g tris-(monochloroisopropyl)-phosphate (flame retardant) were introduced into a 500 ml reaction flask equipped with stirring, cooling and heating means and, after addition of 0.1 g dibutyl tin laurate, were heated with stirring to 50° C. 63.0 g 2,4-TDI were added dropwise with stirring at 50° C., followed by stirring for 20 hours at 50° C. 2.8 g N-phenylaminomethyl dimethoxymethylsilane were then added at room temperature, followed by heating at 60° C. for another hour. The low-viscosity product was stored under nitrogen in a moisture-proof glass vessel. A content of free TDI monomer of <0.05% (detection limit) was determined by GPC analysis.

### Example 3

97 g polypropylene glycol 400 and 40.0 g tris-(monochloroisopropyl)-phosphate (flame retardant) were introduced into a 500 ml reaction flask equipped with stirring, cooling and heating means and, after addition of 0.1 g dibutyl tin laurate, were heated with stirring to 50° C. 63.0 g 2,4-TDI were added dropwise with stirring at 50° C., followed by stirring for 20 hours at 50° C. 6.7 g N-phenylaminomethyl dimethoxymethylsilane were then added at room temperature, followed by stirring for another hour at 60° C. The medium-,viscosity product was stored under nitrogen in a moisture-proof glass vessel. A content of free TDI monomer of <0.05% (detection limit) was determined by GPC analysis.

### Example 4

97 g polypropylene glycol 400 and 40.0 g tris-(monochloroisopropyl)-phosphate (flame retardant) were introduced into a 500 ml reaction flask equipped with stirring, cooling and heating means and, after addition of 0.1 g dibutyl tin laurate, were heated with stirring to 50° C. 63.0 g 2,4-TDI were added dropwise with stirring at 50° C., followed by stirring for 20 hours at 50° C. 8.5 g N-phenylaminomethyl dimethoxymethylsilane were then added at room temperature, followed by stirring for another hour at 80° C. The high-viscosity product was stored under nitrogen in a moisture-proof glass vessel. A content of free TDI monomer of <0.05% (detection limit) was determined by GPC analysis.

### Example 5

### Foam of the Composition of Example 3

1.6 g Tegostab B 8465 (foam stabilizer) and 1.6 g PC Cat. DMDEE (N,N-dimorpholinodiethyl ether) were added to 82 g of the prepolymer mixture of Example 3. The whole was then mixed with 22.7 g propellant 152 a in an aerosol can and foamed. A white, fine-cell, flexible and elastic foam with a tack-free time of 27 mins. was obtained.

### Example 6

### Comparison

36.8 g polypropylene glycol 400 and 92.2 g polypropylene glycol 1000 were introduced into a 500 ml reaction flask equipped with stirring, cooling and heating means and, after addition of 0.04 g dibutyl tin laurate, were heated with stirring to 50° C. 71.8 g 2,4′-MDI were then added with stirring, followed by stirring for 20 hours at 50° C. The low-viscosity product was stored under nitrogen in a moisture-proof glass vessel. A content of free MDI monomer of 2.8% was determined by GPC analysis.

### Example 7

36.8 g polypropylene glycol 400 and 92.2 g polypropylene glycol 1000 were introduced into a 500 ml reaction flask equipped with stirring, cooling and heating means and, after addition of 0.04 g dibutyl tin laurate, were heated with stirring to 50° C. 71.8 g 2,4′-MDI were then added with stirring, followed by stirring for 20 hours at 50° C. 2.3 g N-phenylaminomethyl dimethoxymethyl silane were then added, followed by stirring for another 3 h at 80° C. The low-viscosity product was stored under nitrogen in a moisture-proof glass vessel. A content of free MDI monomer of 0.08% was determined by GPC analysis.

### Example 8

36.8 g polypropylene glycol 400 and 92.2 g polypropylene glycol 1000 were introduced into a 500 ml reaction flask equipped with stirring, cooling and heating means and, after addition of 0.04 g dibutyl tin laurate, were-heated with stirring to 50° C. 71.8 g 2,4′-MDI were then added with stirring, followed by stirring for 20 hours at 50° C. 4.5 g N-phenylaminomethyl dimethoxymethyl silane were then added, followed by stirring for another 3 h at 50° C. The medium-viscosity product was stored under nitrogen in a moisture-proof glass vessel. A content of free MDI monomer of 0.06% was determined by GPC analysis.

### Example 9

36.13 g polypropylene glycol 400 and 92.2 g polypropylene glycol 1000 were introduced into a 500 ml reaction flask equipped with stirring, cooling and heating means and, after addition of 0.04 g dibutyl tin laurate, were heated with stirring to 50° C. 71.8 g 2,4′-MDI were then added with stirring, followed by stirring for 20 hours at 50° C. 6.8 g N-phenylaminomethyl dimethoxymethyl silane were then added, followed by stirring for another 3 h at 80° C. The high-viscosity product was stored under nitrogen in a moisture-proof glass vessel. A content of free MDI monomer of <0.05% (detection limit) was determined by GPC analysis.

### Example 10

### Foam of the Composition of Example 8

1.6 g Tegostab B 8465 (foam stabilizer) and 1.6 g PC Cat. DMDEE (N,N-dimorpholinodiethyl ether) were added to 81.4 g of the prepolymer mixture of Example 8. The whole was then mixed with 21.1 g propellant 152 a in an aerosol can and foamed. A white, fine-cell, elastic and semirigid foam with a tack-free time of 12 mins. was obtained. The foam had a density of 48 g/l.

### Example 11

### Comparison

41.6 g polypropylene glycol 400 and 104.1 g polypropylene glycol 1000 were introduced into a 500 ml reaction flask equipped with stirring, cooling and heating means and, after addition of 0.1 g dibutyl tin laurate, were heated with stirring to 50° C. 104.1 g 2,4′-MDI were then added with stirring, followed by stirring for 20 hours at 50° C. The product was stored under nitrogen in a moisture-proof glass vessel. A content of free MDI monomer of 4.7% was determined by GPC analysis.

### Example 12

41.6 g polypropylene glycol 400 and 104.1 g polypropylene glycol 1000 were introduced into a 500 ml reaction flask equipped with stirring, cooling and heating means and, after addition of 0.1 g dibutyl tin laurate, were heated with stirring to 50° C. 104.1 g 2,4′-MDI were then added with stirring, followed by stirring for 20 hours at 50° C. 75.8 g N-phenylaminomethyl dimethoxymethyl silane were then added, followed by stirring for another 3 h at 80° C. The product was stored under nitrogen in a moisture-proof glass vessel. A content of free MDI monomer of 0.05% (detection limit) was determined by GPC analysis.

### Example 13

Adhesives were produced from the polymers of Examples 11 and 12 together with 0.2% DBU (1,8-diazabicyclo-[5.4.0]-undec-7-ene) and 0.2% DMDEE (N,N-dimorpholinodiethylether) and were used for bonding wood to wood. The tensile shear strengths were determined after storage for 7 days. In addition, holes (diameter=10 mm, depth=10 mm) drilled into a block of wood were filled with the adhesives and the expansion of the adhesives during curing was determined.

| | Example 11 | Example 12 |
|---|---|---|
| Tensile shear strength | 9.3 N/mm² | 11.3 N/mm² |
| Expansion | Considerable (>100%, | None (0%, based on |
| | based on | starting volume) |
| | starting volume) | |

What is claimed is:

1. A composition comprising a polyurethane bearing at least one isocyanate group and a polyurethane bearing a silyl group, the said polyurethanes comprising at least two different types of urethane groups, wherein the silyl group corresponds to general formula I: 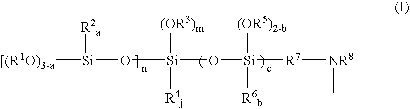
in which R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms, or an aryl group containing 6 to about 24 carbon atoms, R⁷ is an optionally substituted alkylene group containing 1 to about 44 carbon atoms, an optionally substituted cycloalkylene group containing 6 to about 24 carbon atoms, or an optionally substituted arylene group containing 6 to about 24 carbon atoms, n, m, and j are each integers of 0 to 3 (m+n+j=3), a is an integer of 0 to 3, b is an integer of 0 to 2, and c is a number of 0 to 8, and R⁸ is a linear or branched, saturated or unsaturated C₁₋₂₄ alkyl group, a cycloalkyl, phenyl, tolyl, mesityl, trityl or 2,4,6-tri-tert.butyl phenyl group, the composition comprising less than 0.1% by weight of monomeric isocyanates and having a ratio of isocyanate groups to silyl groups of about 90:10 to about 10:90.

2. The composition of claim 1, wherein the different types of urethane groups are derived from an asymmetrical polyisocyanate.

3. The composition of claim 1, wherein the different types of urethane groups are derived from a polyisocyanate containing at least two isocyanate groups that differ in their reactivity to isocyanate-reactive functional groups differs by a factor of at least 1.1.

4. The composition of claim 1, wherein the different types of urethane groups are derived from asymmetrical MDI or IPDI or TDI or a mixture of two or more thereof.

5. A composition comprising at least one polyurethane bearing at least one silyl group or at least one polyurea bearing at least one silyl group, obtained by reacting at least three components A, B and C,
a) component A comprising an asymmetrical polyisocyanate or a mixture of two or more asymmetrical polyisocyanates;
b) component B comprising a silane corresponding to general formula II: 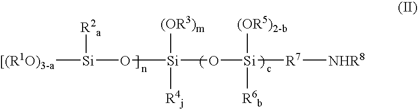
in which the substituents R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms, or an aryl group containing 6 to about 24 carbon atoms, R⁷ is an optionally substituted alkylene group containing 1 to about 44 carbon atoms, an optionally substituted cycloalkylene group containing 6 to about 24 carbon atoms, or an optionally substituted arylene group containing 6 to about 24 carbon atoms, n, m, and j are each integers of 0 to 3 (m+n+j=3), a is an integer of 0 to 3, b is an integer of 0 to 2, and c is a number of 0 to 8, and R⁸ is a linear or branched C₁₋₁₀ alkyl group, a cyclohexyl, phenyl, tolyl, mesityl, trityl or 2,4,6-tri-tert.butyl phenyl group;
and
c) component C comprises a polyol or a mixture of two or more polyols or a polyamine or a mixture of two or more polyamines or a polyol and a mixture of two or more polyamines or a mixture of two or more polyols and a polyamine or a mixture of two or more polyols and a mixture of two or more polyols,
the number ratio of NCO groups to silyl groups being 10:90 to 90:10.

6. The composition of claim 5, further comprising one or more additives selected from the group consisting of drying agents, plasticizers, reactive diluents, antioxidants, catalysts, hardeners, fillers, and UV stabilizers.

7. The composition of claim 5, comprising less than 0.1% by weight monomeric isocyanates.

8. A process for the production of compositions containing at least one polyurethane bearing a silyl group or at least one polyurea bearing a silyl group and at least one polyurethane bearing an NCO group or at least one polyurea bearing an NCO group by reacting
a) at least one asymmetrical diisocyanate with
b) at least one polyol or a mixture of two or more polyols or a polyamine or a mixture of two or more polyamines or a polyol and a mixture of two or more polyamines or a mixture of two or more polyols and a polyamine or a mixture of two or more polyols and a mixture of two or more polyols and
c) at least one silane corresponding to general formula II: 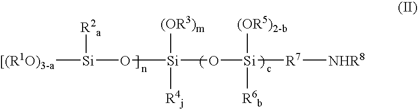
in which the substituents R¹ to R⁶ independently of one another represent a linear or branched, saturated or unsaturated hydrocarbon radical containing 1 to about 24 carbon atoms, a saturated or unsaturated cycloalkyl group containing 4 to about 24 carbon atoms, or an aryl group containing 6 to about 24 carbon atoms, R⁷ is an optionally substituted alkylene group containing 1 to about 44 carbon atoms, an optionally substituted cycloalkylene group containing 6 to about 24 carbon atoms, or an optionally substituted arylene group containing 6 to about 24 carbon atoms, n, m, and j are each integers of 0 to 3 (m+n+j=3), a is an integer of 0 to 3, b is an integer of 0 to 2, and c is a number of 0 to 8, and R⁸ is a linear or branched C₁₋₁₀ alkyl group, a cycloalkyl, phenyl, tolyl, mesityl, trityl or 2,4,6-tri-tert.butyl phenyl group,
the ratio by weight of NCO groups to silane groups in the composition being 10:90 to 90:10.

9. The process of claim 8, wherein in a first step, at least one monomeric asymmetrical diisocyanate is reacted with at least one polyol or polyamine or a mixture thereof to form a compound containing at least one isocyanate group or a mixture of two or more such compounds and, in a following step, the compound is reacted with at least one silane corresponding to general formula II.

10. The composition of claim 1, wherein R⁸ is a cyclopentyl, cyclohexyl, phenyl, tolyl, mesityl trityl, or 2,4,6-tri-tert.butylphenyl group.

11. The composition of claim 1, having a ratio of isocyanate groups to silyl groups of about 80:20 to about 20:80.

12. The composition of claim 11, having a ratio of isocyanate groups to silyl groups of about 70:30 to about 30:70.

13. The composition of claim 12, having a ratio of isocyanate groups to silyl groups of about 60:40 to about 40:60.

14. The composition of claim 2, wherein the asymmetrical polyisocyanate comprises one or more of TDI, MDI, 1-isocyanatomethyl-3-isocyanato-1,5,5-trimethylcyclohexane (IPDI), 1-methyl-2,4-diisoyanatocyclohexane, or hydrogenation products thereof.

15. The composition of claim 3, where the two isocyanate groups differ in their reactivity to isocyanate-reactive functional groups by a factor of at least 1.2.

16. The composition of claim 15, where the two isocyanate groups differ in their reactivity to isocyanate-reactive functional groups by a factor of at least 1.3.

17. The composition of claim 16, where the two isocyanate groups differ in their reactivity to isocyanate-reactive functional groups by a factor of at least 1.4.

18. The composition of claim 17, where the two isocyanate groups differ in their reactivity to isocyanate-reactive functional groups by a factor of at least 1.5.
